(19) United States
(12) Patent Application Publication
(10) Pub. No.: US 2008/0240735 A1
(43) Pub. Date: Oct. 2, 2008

(54) Symmetrical Optical Receiver

(75) Inventor: Martin Bossard, Zurich (SZ)

Correspondence Address: PEARNE & GORDON LLP, 1801 EAST 9TH STREET, SUITE 1200, CLEVELAND, OH, 44114-3108, US

(73) Assignee: HELIX AG

(21) Appl. No.: 11/630,065

(22) PCT Filed: Mar. 21, 2005
(86) PCT No.: PCT/EP2005/051301

§ 371 Date: Dec. 19, 2006

(51) Int. Cl. H04B 10/06

(52) U.S. Cl. 398/202

(57) ABSTRACT

The invention relates to a symmetrical optical receiver comprising a photodiode (Ph) and a symmetrical transimpedance amplifier (TIA). The cathode (K) or respectively the anode (A) of the photodiode (Ph) is connected via a first capacitor (C1) or respectively second capacitor (C2), to the first input or respectively second input, of the symmetrical transimpedance amplifier (TIA). By means of first means (1) or respectively second means (2), a current corresponding to the low-pass-filtered cathode voltage or respectively anode voltage, is conducted into the cathode (K) or respectively conducted away from the anode (A). With the symmetrical optical receiver according to the invention, a low level lower cut-off frequency is able to be achieved with comparatively small coupling capacitors (C1, C2) and with a small circuitry outlay. Moreover, a relatively high voltage drop across the photodiode can be created even with small supply voltages.

### TECHNICAL FIELD

This invention relates to a symmetrical optical receiver. The invention relates in particular to a symmetrical optical receiver with a photodiode and a symmetrical transimpedance amplifier.

### BACKGROUND ART

For reception of optical signals, such as, for example, reception of binary optical signals which are transmitted over a fiber optic cable, a photodiode is frequently used together with a transimpedance amplifier. An optical signal is thereby converted by means of the photodiode into a current signal, and a current signal is converted by means of the transimpedance amplifier into a voltage signal. An optical power able to be captured by a photodiode is thus mapped by means of an optical receiver into a voltage signal proportional to this optical power.

Requirements for an optical receiver include, for example, high bandwidth, large amplification, and minimal noise. These requirements are generally opposed to one another; thus an enlargement of the bandwidth can lead at the same time to an increase in noise, for example. If the optical receiver is achieved completely or partially as a semiconductor chip, using integrated circuit technology, then additional difficulties often arise in meeting definable requirements for an optical receiver. Such difficulties can relate, for instance, to the feasibility of large coupling capacitors on a semiconductor chip.

Known from the state of the art is to design an optical receiver as a symmetrical optical receiver as follows: the cathode and the anode of a photodiode are connected via one resistor each to a reference potential such as a supply voltage and ground, whereby the photodiode is brought to a suitable operating point, and optical signals able to be captured by the photodiode are able to be converted into corresponding current signals. For transmission of the current signals to a symmetrical transimpedance amplifier, the cathode and the anode of the photodiode are connected via one coupling capacitor each, for example to the non-inverting and the inverting input of the symmetrical transimpedance amplifier. The symmetrical transimpedance amplifier converts a definable input current into a voltage signal proportional to this input current, and to be precise, in a ratio that corresponds in particular to the feedback resistors of the symmetrical transimpedance amplifier. With such a circuit, an output voltage signal is generated via the outputs of the symmetrical transimpedance amplifier, which signal is proportional to an optical signal able to be captured by the photodiode. The lower cut-off frequency of such a symmetrical optical receiver is approximately inversely proportional to the product of the resistor for connecting the photodiode to a reference potential and to the coupling capacitor. To ensure operation of the photodiode, the photodiode's connection resistor to a reference potential cannot be designed as large as desired, and a definable low level lower cut-off frequency can only be achieved through a corresponding enlargement of the coupling capacitor. However, as soon as the coupling capacitor is supposed to be implemented on a semiconductor chip, for instance, the enlargement of the coupling capacitor comes up against limits presented by semiconductor chip technology. Thus if such a symmetrical optical receiver is constructed on a semiconductor chip, for example, then it is a drawback that the lower cut-off frequency-defining requirements, defining e.g. a sufficiently low level lower cut-off frequency, often do not suffice.

Described in the patent document U.S. Pat. No. 5,329,115 is a symmetrical optical receiver for generating a voltage signal proportional to an optical signal. A photodiode is connected to a symmetrical transimpedance amplifier via coupling capacitors. The receiver further comprises suitably connected current mirrors as well as current sources controlled via low pass filters. With the current mirrors as well as the controlled current sources, currents are fed in before and after the coupling capacitors in such a way that the required low level lower cut-off frequency is achievable with smaller coupling capacitors. A drawback of such an optical receiver is, however, that corresponding current mirrors and current sources must coincide exactly (so-called “matching”). This leads either to relatively large components having to be used, which leads to an increase in parasitic effects, for example, to additional capacitors having to be provided, which leads to increased space requirements, for instance, or to a relatively high portion of unusable optical receivers being produced. It is moreover a drawback that for small supply voltages, for example for supply voltages of less than 5 volts, only an insufficient voltage drop via the photodiode is able to be created. It is furthermore a disadvantage that a relatively high outlay in circuitry is necessary. This leads, on the one hand, to more sources of noise and, on the other hand, to a higher space requirement, especially when implementing such a receiver on a semiconductor chip.

### DISCLOSURE OF INVENTION

It is an object of the present invention to propose a new symmetrical optical receiver which does not have the drawbacks of the state of the art. In particular, it is an object of the invention to propose a symmetrical optical receiver, with which a definable low level lower cut-off frequency is achievable with small coupling capacitors, with high precision and with minimal circuitry complexity.

These objects are achieved according to the present invention in particular through the elements of the independent claim. Further advantageous embodiments follow moreover from the dependent claims and from the specification.

The above-mentioned objects are achieved through the present invention in particular with a symmetrical optical receiver with a photodiode and a symmetrical transimpedance amplifier, the photodiode comprising a cathode and an anode, the symmetrical transimpedance amplifier comprising a first input and a second input, the cathode of the photodiode being connected via a first capacitor to the first input of the symmetrical transimpedance amplifier, the anode of the photodiode being connected via a second capacitor to the second input of the symmetrical transimpedance amplifier, the cathode of the photodiode being connected to first means, the first means comprising a low pass filter for filtering the voltage between the cathode of the photodiode and a reference potential, and by means of the first means a current corresponding to the low-pass-filtered voltage being able to be fed into the cathode of the photodiode, the anode of the photodiode being connected to second means, the second means comprising a low pass filter for filtering the voltage between the anode of the photodiode and a reference potential, and by means of the second means a current corresponding to the low-pass-filtered voltage being able to be conducted away from the anode of the photodiode. Such a symmetrical optical receiver has in particular the advantage that a definable low level lower cut-off frequency of the optical receiver is achievable with relatively small capacitors, with relatively high precision and with a relatively minimal circuitry complexity. Through the inventive feeding into the cathode of the photodiode of a current corresponding to a low-pass-filtered voltage of the cathode, and the conducting away from the anode of the photodiode of a current corresponding to a low-pass-filtered voltage of the anode, in particular the operating point of the photodiode is adjusted. In that the feeding or respectively conducting away of a current are in accordance with a high impedance configuration, achieved, or respectively forced, is that low frequency current signals of the photodiode are transmitted over the coupling capacitors. Current signals are thus also transmittable over smaller coupling capacitors.

In an embodiment variant, the first means of the symmetrical optical receiver comprise a first MOS transistor, the first MOS transistor having a source, a gate and a drain, and the second means of the symmetrical optical receiver comprise a second MOS transistor, the second transistor having a drain, a gate and a source. The cathode of the photodiode is connected via a first resistor to the gate of the first MOS transistor, the drain of the first MOS transistor being connected to the cathode of the photodiode, the gate of the first MOS transistor being connected via a third capacitor to a first reference potential, the source of the first MOS transistor being connected to the first reference potential, the anode of the photodiode being connected via a second resistor to the gate of the second MOS transistor, the drain of the second MOS transistor being connected to the anode of the photodiode, the gate of the second MOS transistor being connected via a fourth capacitor to a second reference potential, and the source of the second MOS transistor being connected to the second reference potential. This embodiment variant is also achievable by using bipolar transistors instead of using MOS transistors. The solution according to this embodiment variant is distinguished by a simple and small circuitry outlay. This leads to lower noise and to smaller space requirements with integration on a semiconductor chip.

In a further embodiment variant, the first means comprise a first MOS transistor, the first MOS transistor having a source, a gate and a drain, and the second means comprise a second MOS transistor, the second MOS transistor having a drain, a gate and a source. The cathode of the photodiode is connected to a first input of a first OTA (OTA: Operational Transconductance Amplifier), a second input of the first OTA being connected to a first reference voltage, an output of the first OTA being connected to the gate of the first MOS transistor, the drain of the first MOS transistor being connected to the cathode of the photodiode, the gate of the first MOS transistor being connected via a third capacitor to a first reference potential, the source of the first MOS transistor being connected to the first reference potential, the anode of the photodiode being connected to a first input of a second OTA, a second input of the second OTA being connected to a second reference voltage, an output of the second OTA being connected to the gate of the second MOS transistor, the drain of the second MOS transistor being connected to the anode of the photodiode, the gate of the second MOS transistor being connected via a fourth capacitor to a second reference potential, and the source of the second MOS transistor being connected to the second reference potential. This embodiment variant is again achievable by using bipolar transistors instead of using MOS transistors. This embodiment variant is also achievable by using operational amplifiers instead of using OTAs, the third and the fourth capacitor being dispensed with or being disposed differently. The use of operational amplifiers is particularly advantageous when using bipolar transistors for which a definable base current must be available. The cathode of the photodiode is thereby connected via a first resistor to a first input of a first operational amplifier; a second input of the operational amplifier is connected to a first reference voltage, the first input of the operational amplifier is connected via a capacitor to an output of the operational amplifier, the output of the operational amplifier is connected to the base of a first bipolar transistor, the cathode of the photodiode is connected to the collector of the first bipolar transistor, and the emitter of the first bipolar transistor is connected to the first reference potential. In a corresponding way, a second operational amplifier and a second bipolar transistor are connected to the anode of the photodiode and the second reference potential. Achieved through such a use of OTAs or respectively operational amplifiers is that the potential of the cathode or respectively the potential of the anode are definable by means of the reference voltages in such a way that, via the photodiode, even for relatively small supply voltages, i.e. for a relatively small potential difference between the first and the second reference potential, a sufficiently large voltage drop is able to be created via the photodiode.

### BRIEF DESCRIPTION OF DRAWINGS

Embodiment variants of the present invention will be described in the following with reference to examples. The examples of the embodiments are illustrated by the following attached figures:

FIG. 1 shows a block diagram of the symmetrical optical receiver according to the invention.

FIG. 2 shows an embodiment variant of the symmetrical optical receiver according to the invention with MOS transistors, resistors and capacitors.

FIG. 3 shows a further embodiment variant of the symmetrical optical receiver with MOS transistors, OTAs and capacitors.

### MODES FOR CARRYING OUT THE INVENTION

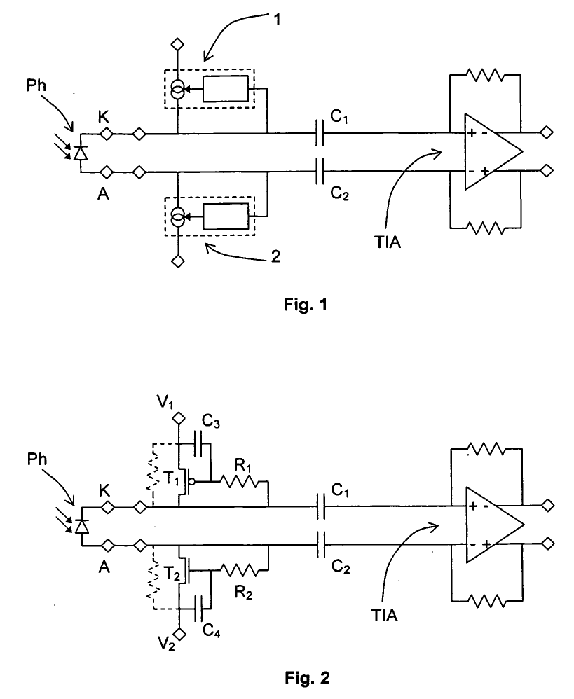

In FIGS. 1 to 3, same reference symbols refer to same elements.

In FIG. 1, the reference symbol Ph refers to a photodiode, such as a PIN photodiode (PIN: Positive Intrinsic Negative), for example, the reference symbol K to the cathode of the photodiode Ph, and the reference symbol A to the anode of the photodiode Ph. The cathode K of the photodiode Ph is connected via a capacitor C₁ to the non-inverting input of a transimpedance amplifier TIA (TIA: Transimpedance Amplifier). The anode A of the photodiode Ph is connected via a capacitor C₂ to the inverting input of the transimpedance amplifier TIA. The capacitor C₁ or respectively C₂ can be just as well connected to the inverting or respectively to the non-inverting input of the transimpedance amplifier, however. In FIG. 1, the reference numeral 1 refers to first means of feed of a current corresponding to the cathode voltage into the cathode K of the photodiode Ph, and the reference numeral 2 refers to second means of conducting a current corresponding to the anode voltage away from the anode A of the photodiode Ph. The reference symbol TIA refers to a transimpedance amplifier for converting and amplifying a current signal transmittable over the capacitors C₁ and C₂ into a voltage signal at the outputs of the transimpedance amplifier. The first means 1, the second means 2, the capacitors C₁ and C₂ as well as the transimpedance amplifier TIA are configured, for example, as integrated circuit in a semiconductor chip. The semiconductor chip has, for example, pins for connection of the cathode K and the anode A of a photodiode Ph, pins for connection of the semiconductor chip to reference potentials V₁ and V₂, such as, for instance, a supply voltage of between 3 to 5 volts and ground, for supplying the semiconductor chip with a supply voltage, and pins for measuring the output voltage of the transimpedance amplifier TIA.

In FIG. 2, the reference symbols T₁ and T₂ refer to MOS transistors such as, for example, a NMOS transistor T₁ and a PMOS transistor T₂. It is to be mentioned here that a symmetrical optical receiver according to the invention can also be constructed using bipolar technology. In bipolar technology, the reference symbols T₁ and T₂ refer to corresponding bipolar transistors, such as, for example, a PNP transistor T₁ and a NPN transistor T₂. The reference numerals R₁ or respectively R₂ in FIG. 2 refer to resistors, and the reference symbols C₃ or respectively C₄ refer to capacitors. The cathode K of the photodiode Ph is connected via a serial connection of the resistor R₁ and of the capacitor C₃ to a first reference potential V₁, such as, for example, a supply voltage of 3 to 5 volts. The cathode is connected via the resistor R₁ to the gate or respectively the base of a MOS transistor T₁ or respectively of a bipolar transistor T₁. The drain or respectively collector of the MOS transistor T₁ or respectively of the bipolar transistor T₁ is connected to the cathode K of the photodiode Ph. The source or respectively the emitter of the MOS transistor T₁ or respectively of the bipolar transistor T₁ is connected to the first reference potential V₁, i.e. to a supply voltage of 3 to 5 volts, for example. The anode A of the photodiode Ph is connected via a serial connection of the resistor R₂ and of the capacitor C₄ to a second reference potential V₂, such as the ground, for example. The cathode is connected via the resistor R₁ to the gate or respectively to the base of a MOS transistor T₁ or respectively of a bipolar transistor T₁. The drain or respectively collector of the MOS transistor T₂ or respectively of the bipolar transistors T₂ is connected to the anode A of the photodiode Ph. The source or respectively the emitter of the MOS transistor T₂ or respectively of the bipolar transistors T₂ is connected to the second reference potential V₂, i.e. to the ground, for example. Thus the first means 1 described in FIG. 1 are formed by means of the transistor T₁, the resistor R₁ and the capacitor C₁. Correspondingly, the second means 2 described in FIG. 1 are formed by means of the transistor T₂, the resistor R₂ and the capacitor C₂. Such a symmetrical optical receiver is characterized by the very high impedance path between the cathode K or respectively the anode A and the supply voltage V₁ or respectively the ground V₂. Since the lower cut-off frequency is approximately inversely proportional to the product of this high impedance path with the coupling capacitors C₁, C₂, a low level lower cut-off frequency of the optical receiver can be achieved even for smaller coupling capacitors C₁ and C₂. Instabilities in this circuit can be prevented by additional high impedance resistors connected in parallel to this high impedance path. In FIG. 2 such resistors have been drawn in broken lines.

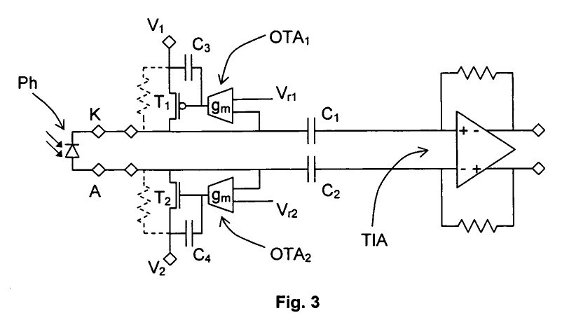

In FIG. 3, the reference symbols OTA₁ or respectively OTA₂ refer to OTAs (OTA: Operational Transconductance Amplifier) with a corresponding definable transmission value gₘ. The OTA₁ or respectively OTA₂ is used instead of the resistor R₁ or respectively R₂ from FIG. 2. A first input of the OTA₁ or respectively of the OTA₂ is connected to the cathode K or respectively to the anode A of the photodiode Ph. A second input of the OTA₁ or respectively of the OTA₂ is connected to a first reference voltage Vᵣ₁ or respectively to a second reference voltage Vᵣ₂. An output of the OTA₁ or respectively of the OTA₂ is connected to the gate of the transistor T₁ or respectively T₂. By means of suitable reference voltages Vᵣ₁ or respectively Vᵣ₂ the potentials of the cathode and of the anode are put at suitable values, so that even for relatively small supply voltages of the circuit a sufficiently large voltage drop is able to be created via the photodiode. The reference voltages Vᵣ₁ or respectively Vᵣ₂ are able to be generated by means of resistors through high ohmic voltage dividers, for example. Instabilities in such a circuit with OTAs, transistors and resistors can be prevented by means of an additional high ohmic resistor between the cathode K and the first reference voltage V₁ as well as an additional resistor between the anode A and the second reference potential V₂. In FIG. 3 such resistors have been drawn in broken lines.

The use of OTAs is particularly advantageous if the transistors T₁ and T₂ are designed as MOS transistors. If the transistors T₁ and T₂ are designed as bipolar transistors, then using fed-back operational amplifiers in particular, instead of using OTAs, is especially advantageous, a non-inverting input of an operational amplifier being connected via a capacitor to an output of the operational amplifier. The inverting input of a first such fed-back operational amplifier is connected to the reference voltage Vᵣ₁, the non-inverting input of the first fed-back operational amplifier is connected via a resistor to the cathode K, and the output of the first fed-back operational amplifier is connected to the base of the first bipolar transistor T₁. Analogously, the inverting input of a second such fed-back operational amplifier is connected to the reference voltage Vᵣ₂, the non-inverting input of the second fed-back operational amplifier is connected via a resistor to the cathode K as well as via a capacitor to the output of the second fed-back operational amplifier, and the output of the second fed-back operational amplifier is connected to the base of the second bipolar transistor T₂.

1. A symmetrical optical receiver with a photodiode (Ph) and a symmetrical transimpedance amplifier (TIA), the photodiode comprising a cathode (K) and an anode (A), and the symmetrical transimpedance amplifier (TIA) including a first input and a second input, wherein
the cathode (K) of the photodiode (Ph) is connected via a first capacitor (C₁) to the first input of the symmetrical transimpedance amplifier (TIA),
the anode (A) of the photodiode (Ph) is connected via a second capacitor (C₂) to the second input of the symmetrical transimpedance amplifier (TIA),
the cathode (K) of the photodiode (Ph) is connected to first means (1), the first means (1) comprising a low pass filter for filtering the voltage between the cathode (K) of the photodiode (Ph) and a reference potential, and a current corresponding to the low-pass-filtered voltage being able to be fed into the cathode (K) of the photodiode (Ph) by means of the first means (1), and
the anode (A) of the photodiode (Ph) being connected to second means (1), the second means (1) comprising a low pass filter for filtering the voltage between the anode (A) of the photodiode (Ph) and a reference potential, and a current corresponding to the low-pass-filtered voltage being able to be conducted away from the anode (A) of the photodiode (Ph) by means of the second means (2).

2. The symmetrical optical receiver according to claim 1, wherein the first means (1) comprise a first MOS transistor (T₁), the first MOS transistor (T₁) including a source, a gate and a drain, the second means (2) comprise a second MOS transistor (T₂), the second transistor (T₂) including a drain, a gate and a source, the cathode (K) of the photodiode (Ph) being connected via a first resistor (R₁) to the gate of the first MOS transistor (T₁), the drain of the first MOS transistor (T₁) is connected to the cathode (K) of the photodiode (Ph), the gate of the first MOS transistor (T₁) is connected via a third capacitor (C₃) to a first reference potential (V₁), the source of the first MOS transistor (T₁) is connected to the first reference potential (V₁), the anode (A) of the photodiode (Ph) is connected via a second resistor (R₂) to the gate of the second MOS transistor (T₂), the drain of the second MOS transistor (T₂) is connected to the anode (A) of the photodiode (Ph), the gate of the second MOS transistor (T₂) is connected via a fourth capacitor (C₄) to a second reference potential (V₂), and the source of the second MOS transistor (T₂) is connected to the second reference potential (V₂).

3. The symmetrical optical receiver according to claim 1, wherein die first means (1) comprise a first bipolar transistor (T₁), the first bipolar transistor (T₁) including an emitter, a base and a collector, the second means (2) comprise a second bipolar transistor (T₂), the second bipolar transistor (T₂) including a collector, a base and an emitter, the cathode (K) of the photodiode (Ph) is connected via a first resistor (R₁) to the base of the first bipolar transistor (T₁), the collector of the first bipolar transistor (T₁) is connected to the cathode (K) of the photodiode (Ph), the base of the first bipolar transistor (T₁) is connected via a third capacitor (C₃) to a first reference potential (V₁), the emitter of the first bipolar transistor (T₁) is connected to the first reference potential (V₁), the anode (A) of the photodiode (Ph) is connected via a second resistor (R₂) to the base of the second bipolar transistor (T₂), the collector of the second bipolar transistor (T₂) is connected to the anode (A) of the photodiode (Ph), the base of the second bipolar transistor (T₂) is connected via a fourth capacitor (C₄) to a second reference potential (V₂), and the emitter of the second bipolar transistor (T₂) is connected to the second reference potential (V₂).

4. The symmetrical optical receiver according to claim 1, wherein the first means (1) comprise a first MOS transistor (T₁), the first MOS transistor (T₁) including a source, a gate and a drain, the second means (2) comprise a second MOS transistor (T₂), the second MOS transistor (T₂) including a drain, a gate and a source, the cathode (K) of the photodiode (Ph) is connected to a first input of a first OTA (OTA₁), a second input of the first OTA (OTA₁) is connected to a first reference voltage (Vᵣ₁), an output of the first OTA (OTA₁) is connected to the gate of the first MOS transistor (T₁), the drain of the first MOS transistor (T₁) is connected to the cathode (K) of the photodiode (Ph), the gate of the first MOS transistor (T₁) is connected via a third capacitor (C₃) to a first reference potential (V₁), the source of the first MOS transistor (T₁) is connected to the first reference potential (V₁), the anode (A) of the photodiode (Ph) is connected to a first input of a second OTA (OTA₂), a second input of the second OTA (OTA₂) is connected to a second reference voltage (Vᵣ₂), an output of the second OTA (OTA₂) is connected to the gate of the second MOS transistor (T₂), the drain of the second MOS transistor (T₂) is connected to the anode (A) of the photodiode (Ph), the gate of the second MOS transistor (T₂) is connected via a fourth capacitor (C₄) to a second reference potential (V₂), and the source of the second MOS transistor (T₂) is connected to the second reference potential (V₂).

5. The symmetrical optical receiver according to claim 1, wherein the first means (1) comprise a first bipolar transistor (T₁), the first bipolar transistor (T₁) including an emitter, a base and a collector, the second means (2) comprise a second bipolar transistor (T₂), the second bipolar transistor (T₂) including a collector, a base and an emitter, the cathode (K) of the photodiode (Ph) is connected via a resistor to a first input of a first operational amplifier, a second input of the first operational amplifier is connected to a first reference voltage (Vri), the first input of the first operational amplifier is connected via a capacitor to an output of the first operational amplifier, the output of the first operational amplifier is connected to the base of the first bipolar transistor (T₁), the collector of the first bipolar transistor (T₁) is connected to the cathode (K) of the photodiode (Ph), the emitter of the first bipolar transistor (T₁) is connected to the first reference potential (V₁), the anode (A) of the photodiode (Ph) is connected via a resistor to a first input of a second operational amplifier, a second input of the second operational amplifier is connected to a second reference voltage (Vᵣ₂), the first input of the second operational amplifier is connected via a capacitor to an output of the second operational amplifier, the output of the second operational amplifier is connected to the base of the second bipolar transistor (T₂), the collector of the second bipolar transistor (T₂) is connected to the anode (A) of the photodiode (Ph), and the emitter of the second bipolar transistor (T₂) is connected to the second reference potential (V₂).
